(19) United States
(12) Patent Application Publication
(10) Pub. No.: US 2015/0206460 A1
(43) Pub. Date: Jul. 23, 2015

(54) NAME PLATE HOLDER

(71) Applicant: Robert C. Napieralski, Ada, MI (US)

(72) Inventor: Robert C. Napieralski, Ada, MI (US)

(21) Appl. No.: 14/567,198

(22) Filed: Dec. 11, 2014

Related U.S. Application Data
(60) Provisional application No. 61/929,667, filed on Jan. 21, 2014.

(51) Int. Cl. G09F 3/20; G09F 7/04; G09F 7/10

(52) U.S. Cl. CPC G09F 3/20; G09F 7/10; G09F 7/04; G09F 2007/1843

(57) ABSTRACT

A name plate holder is provided for mounting atop a work area divider or partition wall within a work area. The name plate holder includes a top panel that extends over an upper surface of the partition wall, a front panel that extends downwardly from the top panel and is configured to support a name plate for display in the work area, and a back panel that extends downwardly from a rearward edge of the top panel. Optionally, the back panel includes a display surface that is accessible from within a personal work space that is at least partially defined by the partition wall on which the name plate holder is supported.

### CROSS REFERENCE TO RELATED APPLICATION

The present application claims the benefit of U.S. provisional application Ser. No. 61/929,667, filed Jan. 21, 2014, which is hereby incorporated herein by reference in its entirety.

### FIELD OF THE INVENTION

The present invention is directed to name plate holders, and particularly to name plate holders displayed in work areas.

### BACKGROUND OF THE INVENTION

Work areas, and particularly indoor office work areas, are often divided or sub-divided into personal work spaces by walls or dividers. The walls or dividers generally extend a portion of the distance between a floor surface and a ceiling surface, and may typically range from about 3 feet to 6 feet in height. Such walls or dividers are often labeled with a name plate to indicate the identity of the person or persons who typically work in a nearby work space. However, typical name tags or name plates can be difficult to mount in a level orientation, and may not accommodate variations such as long names that require extra length.

### SUMMARY OF THE INVENTION

The present invention provides a name plate holder that is supportable by an upper surface of a wall portion that serves as a work area divider. The name plate holder can be made to accommodate different lengths of name plates and/or widths of dividers or wall portions, assumes a level orientation when positioned along the wall portion, and may provide additional functions for a person located in a personal work space associated with the wall portion, such as a writing area and/or a surface to which documents or other items may be attached and displayed with magnets or other fasteners.

According to one form of the present invention, a name plate holder includes a top panel that extends over an upper surface of a wall portion of a work area divider, and forward and back panels that both extend downwardly from the top panel. The top panel has a forward edge portion that is directed away from a personal work space of the work area, and a rearward edge portion that is directed toward the personal work space. The forward panel extends downwardly from the forward edge portion of the top panel, and is configured to support a name plate. The back panel extends downwardly from the rearward edge portion of the top panel and, optionally, is accessible from the personal work space and provides a writing surface, a display surface, or other function.

Accordingly, the name plate holder of the present invention provides a support for name plates, which ensures that a given name plate is held in a level orientation. The name plates may be readily replaceable on the holder, without need for any tools, and the holder can provide other useful functions for a person located in a personal work space that is partially defined by the work area divider on which the name plate holder is mounted.

These and other objects, advantages, purposes, and features of the present invention will become more apparent upon review of the following specification in conjunction with the drawings.

### BRIEF DESCRIPTION OF THE DRAWINGS

FIG. 1 is a front perspective view of a name plate holder in accordance with the present invention, shown with a nameplate being slid into position;

FIG. 2 is a rear perspective view of the name plate holder of FIG. 1;

FIG. 3 is an exploded right side elevation of the name plate holder of FIG. 1; and

FIG. 4 is a rear perspective view of the name plate holder, shown mounted atop a work area divider or partition wall.

### DESCRIPTION OF THE PREFERRED EMBODIMENTS

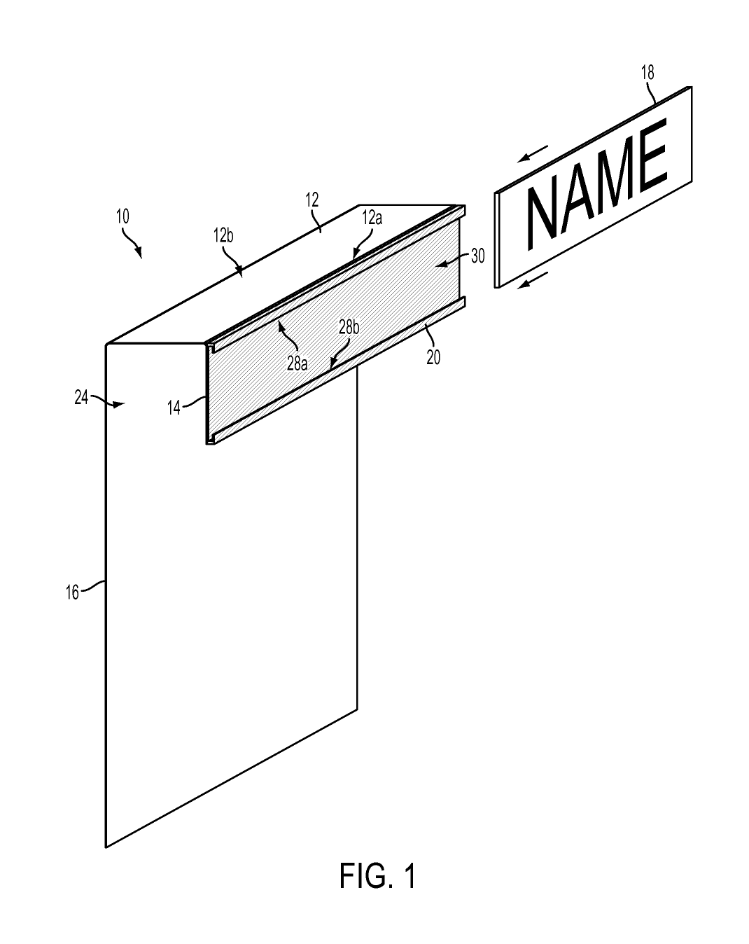

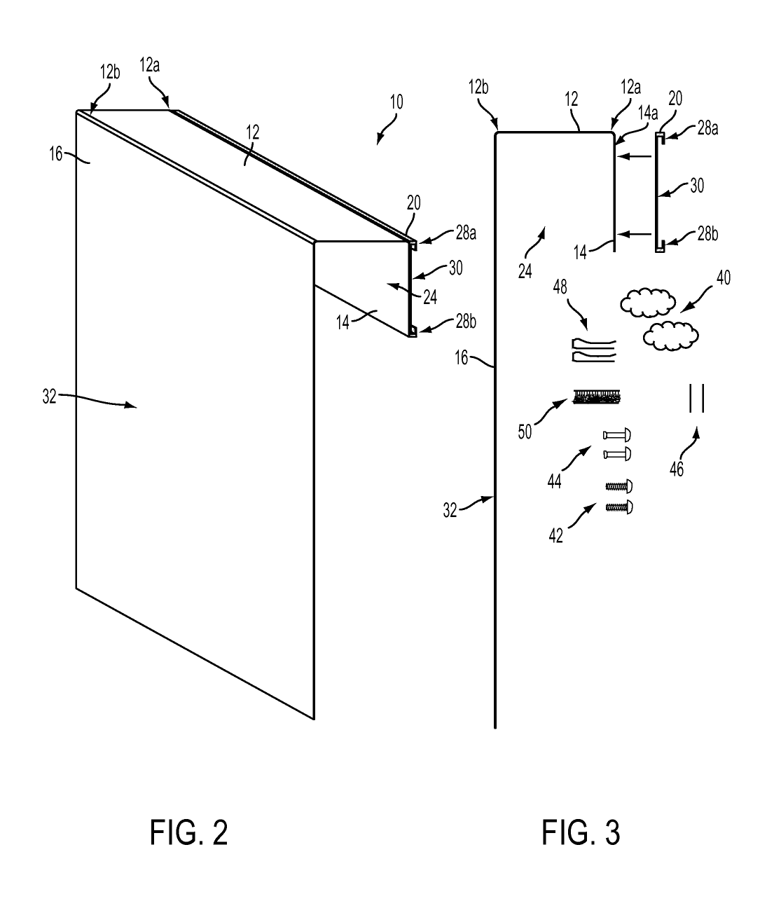

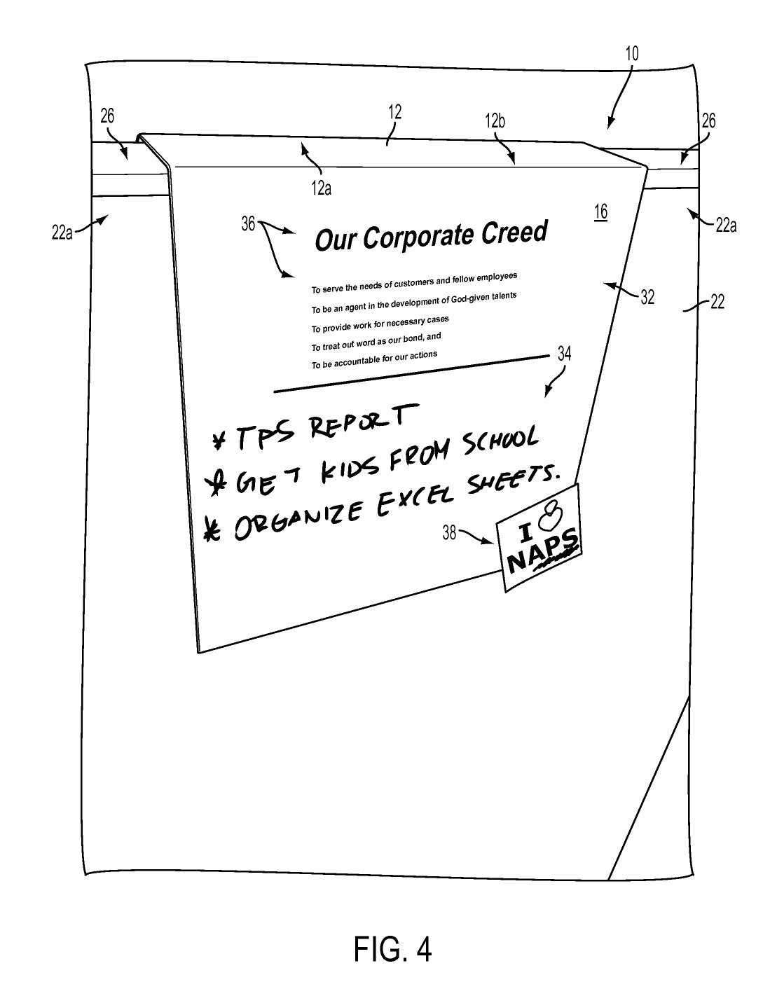

Referring now to the drawings and the illustrative embodiment depicted therein, a name plate holder 10 includes a top panel 12, a front or forward panel 14, and a back panel 16 (FIGS. 1-3). Front panel 14 is configured to support a name plate 18 (FIG. 1), which is received in a name plate bracket 20 mounted to a front surface 14a (FIG. 3) of front panel 14. Name plate holder 10 is shaped in a manner that allows it to be supported on a work area divider 22 (FIG. 4), such as a cubicle or partition wall, a privacy wall, or the like. This arrangement allows name plate 18 to be displayed in a level orientation outside of a personal work space of a work area, while back panel 16 may be visible from the personal work space, and may provide additional functions to a person in the work space, such as a writing or display surface, as will be described in more detail below.

Top panel 12 includes a forward edge portion 12a and a rearward edge portion 12b (FIGS. 1-4). Front panel 14 extends downwardly from forward edge portion 12a, and back panel 16 extends downwardly from rearward edge portion 12b, with front panel 14 and back panel 16 being substantially parallel to one another and perpendicular to top panel 12, such as shown in FIG. 3. Front panel 14 and back panel 16 are spaced apart by top panel 12 so as to form an elongate channel 24 (FIGS. 1-3) that receives an upper portion 22a of work area divider 22, with top panel 12 resting on a top surface 26 of the work area divider 22, such as shown in FIG. 4.

Although it is envisioned that name plate 18 could be permanently or removably attached directly to front surface 14a of front panel 14, in the illustrated embodiment name plate bracket 20 is coupled directly to front panel 14 and allows name plate 18 to be installed and removed or replaced at the bracket 20 as desired. Name plate bracket 20 includes an upper channel portion 28a located near forward edge portion 12a of top panel 12, and a lower channel portion 28b located near a lower edge of front panel 14 (FIGS. 1-3). A generally planar surface 30 extends between the upper and lower channel portions 28a, 28b, so that name plate bracket 20 has an elongated (vertically-stretched) C-shaped profile (FIG. 3). Name plate bracket 20 is shaped to slidably receive name plate 18, with upper and lower edge portions of the name plate received in the respective upper and lower channel portions 28a, 28b of name plate bracket 20, such as shown in FIG. 1.

Name plate bracket 20 may be attached to front panel 14 via substantially any known method such as, for example, an adhesive material (glue, double-sided tape, etc.); welding; screws, bolts, or other threaded fasteners; rivets; magnets; resilient clips; hook-and-loop fasteners; or the like. Optionally, it is envisioned that a name plate bracket may be integrally or unitarily formed with the front panel of the name plate holder, such as in an extrusion process.

Back panel 16 may be substantially larger in surface area than front panel 14, such as to provide a writing surface and/or a display surface. For example, and as shown in FIG. 4, a rearwardly or outwardly-facing surface 32 of back panel 16 may be painted, coated, or otherwise finished in a manner that permits the use of erasable markers (such as “dry-erase” markers) for hand-written notes 34. Optionally, surface 32 may be pre-printed with text 36 or designs or other indicia, and back panel 16 may be magnetically permeable to facilitate the use of magnets 38.

Top panel 12, front panel 14, and back panel 16 may be substantially planar, such as shown in the drawings, or may have other shapes or features to provide different appearance and/or functionality for the name plate holder. For example, felt, rubber, or silicone pads or the like may be attached to a bottom surface of top panel 12 to limit or prevent the marring of top surface 26 of the work area divider 22, and/or to increase friction between the name plate holder 10 and the upper portion 22a of work area divider 22, such as to avoid inadvertent sliding of the name plate holder along the work area divider. Additional pads (such as felt or the “hook” portion of a hook-and-loop fastener) may be attached along inboard surfaces of front panel 14 and/or back panel 16, which pads can engage respective outboard surfaces of work area divider 22 to help hold name plate holder 10 in place along the work area divider 22.

In the illustrated embodiment, top panel 12, front panel 14, and back panel 16 are unitarily formed from a single sheet material, such as steel, aluminum, or resinous plastic. For example, a single sheet material may be cut to a desired width, and then bent or otherwise formed to create the separate panels 12, 14, 16. It will be appreciated that name plate holder 10 may be readily cut to substantially any desired length to accommodate names, labels, or indicia of different lengths, and that its other dimensions may also be varied to accommodate partition walls of different thicknesses, desired amounts of writing or display area, or the like.

Thus, the name plate holder of the present invention can be readily installed along the top of a work area divider or partition, without the use of tools, and in a manner that allows the name plate holder to automatically assume a level orientation. The name plate holder facilitates the replacement of name plates as needed, and can be readily sized to fit work area dividers of different thicknesses, while optionally providing a display area within a personal work space, so that a person within the work space may use the name plate holder for notes, holding or displaying documents, and the like.

Changes and modifications in the specifically-described embodiments can be carried out without departing from the principles of the present invention, which is intended to be limited only by the scope of the appended claims, as interpreted according to the principles of patent law including the doctrine of equivalents.

1. A name plate holder for mounting atop a work area divider or partition wall, said name plate holder comprising:
a top panel configured to extend over an upper surface of a wall portion of the work area divider, said top panel having a forward edge portion directed away from a personal work space of the work area and a rearward edge portion directed toward the personal work space of the work area;
a name plate;
a front panel extending downwardly from said forward edge portion of said top panel, wherein said front panel is configured to support-a said name plate; and
a back panel extending downwardly from said rearward edge portion of said top panel, wherein said back panel comprises an erasable writing surface that is accessible from the personal work space of the work area.

2. The name plate holder of claim 1, wherein said front panel and said back panel are substantially parallel to one another and substantially perpendicular to said top panel.

3. The name plate holder of claim 1, wherein said top panel, said front panel, and said back panel are unitarily formed.

4. (canceled)

5. The name plate holder of claim 1, wherein said back panel comprises a magnetically permeable material and is accessible from the personal work space of the work area.

6. The name plate holder of claim 1, wherein said front panel is configured to removably support said name plate, whereby said name plate is removable and replaceable along said front panel.

7. The name plate holder of claim 6, further comprising a name plate bracket coupled to said front panel and configured to secure said name plate to said front panel.

8. The name plate holder of claim 7, wherein said name plate bracket comprises upper and lower channel portions configured to receive respective upper and lower edge portions of said name plate.

9. The name plate holder of claim 7, wherein said name plate bracket is coupled to said front panel via at least one chosen from: (i) an adhesive, (ii) welding, (iii) threaded fasteners, (iv) rivets, (v) magnets, (vi) resilient clips, and (vii) hook-and-loop fasteners.

10. (canceled)

11. A name plate holder for mounting atop a work area divider or partition wall, said name plate holder comprising:
a top panel configured to extend over an upper surface the work area divider or partition wall, said top panel having a forward edge portion directed away from a personal work space of the work area and a rearward edge portion directed toward the personal work space of the work area;
a front panel extending downwardly from said forward edge portion of said top panel, wherein said front panel is configured to support a name plate;
a name plate bracket at said front panel and configured to secure the name plate to said front panel, said name plate bracket comprising a channel portion configured to receive an edge portion of the name plate;
a generally planar back panel extending downwardly from said rearward edge portion of said top panel, wherein said back panel is substantially parallel to said front panel and substantially perpendicular to said top panel; and
an erasable writing surface along a surface of said back panel, wherein said writing surface is accessible from the personal work space of the work area.

12. The name plate holder of claim 11, wherein said top panel, said front panel, and said back panel are unitarily formed.

13. The name plate holder of claim 12, wherein said top panel, said front panel, and said back panel comprise sheet metal.

14. The name plate holder of claim 13, wherein said sheet metal comprises a magnetically permeable material.

15. The name plate holder of claim 11, wherein said name plate bracket is configured to removably support the name plate, whereby the name plate is removable and replaceable along said front panel.

16. (canceled)

17. The name plate holder of claim 11, wherein said channel portion of said name plate bracket comprises upper and lower channel portions configured to receive respective upper and lower edge portions of the name plate.

18. The name plate holder of claim 17, wherein said name plate bracket is coupled to said front panel via at least one chosen from: (i) an adhesive, (ii) welding, (iii) threaded fasteners, (iv) rivets, (v) magnets, (vi) resilient clips, and (vii) hook-and-loop fasteners.

19. The name plate holder of claim 11, further in combination with the name plate.

20. A name plate holder for mounting atop a work area divider or partition wall, said name plate holder comprising:
a top panel configured to extend over an upper surface the work area divider or partition wall, said top panel having a forward edge portion directed away from a personal work space of the work area and a rearward edge portion directed toward the personal work space of the work area;
a front panel extending downwardly from said forward edge portion of said top panel;
a name plate bracket coupled to a forward surface of said front panel and configured to releasably secure a name plate to said front panel, said name plate bracket having upper and lower channel portions configured to receive respective upper and lower edge portions of the name plate;
a generally planar back panel extending downwardly from said rearward edge portion of said top panel, wherein said back panel is substantially parallel to said front panel and substantially perpendicular to said top panel, and wherein said back panel comprises a magnetically permeable material; and
an erasable writing surface along a surface of said back panel, wherein said writing surface is accessible from the personal work space of the work area.
